(19) United States
(12) Patent Application Publication
(10) Pub. No.: US 2007/0065678 A1
(43) Pub. Date: Mar. 22, 2007

(54) Electro-static chuck with non-sintered aln and a method of preparing the same

(76) Inventors: Kyung-hyun Ko, Kyunggi-Do (KR); Ha-yong Lee, Kyunggi-Do (KR); Jae-hong Lee, Kyunggi-Do (KR); Hung-sang Lee, Kyunggi-Do (KR); Jae-jung Lee, Kyunggi-Do (KR)

Correspondence Address: CANTOR COLBURN, LLP, 55 GRIFFIN ROAD SOUTH, BLOOMFIELD, CT, 06002, US

(21) Appl. No.: 10/575,031

(22) PCT Filed: Oct. 6, 2004
(86) PCT No.: PCT/KR04/02547

§ 371 Date: Apr. 7, 2006

(30) Foreign Application Priority Data
Oct. 9, 2003 (KR) 10-2003-0070114

(51) Int. Cl. B32B 9/00; B32B 19/00; H05H 1/24; B05D 1/12; B05D 3/02

(52) U.S. Cl. 428/698; 427/569; 427/180; 427/372.2

(57) ABSTRACT

The present invention relates to an electro-static chuck with non-sintered AlN and a method of preparing the same. Especially, the present invention relates to the electro-static chuck with non-sintered AlN which having coated aluminum nitride (AlN) layer as a dielectric one on the purpose of chucking the wafers in the process of wafers and a method of preparing the same. The electro-static chuck of the present invention has excellent dielectric characteristics, bonding strength and thermal conductivity by forming an AlN layer as a dielectric one without sintering process or bonding process with binders.

### TECHNICAL FIELD

The present invention relates to an electro-static chuck with non-sintered aluminum nitride (AlN) and a method for preparing the same and more particularly, it relates to an electro-static chuck with non-sintered aluminum nitride (AlN) having a coating layer of aluminum nitride as a dielectric layer used to fix a wafer in processing the wafer, which is formed by bonding the dielectric without sintering process or bonding process and has good bonding strength and thermal conductivity as well as excellent dielectric characteristics and a method for preparing the same.

### BACKGROUND ART

Generally, in a processing chamber used for etching and deposition of semiconductor elements, a wafer should be firmly fixed on a chuck to ensure the process precision. In case of an electro-static chuck, a wafer is fixed by static electricity induced on the chuck.

The electro-static chuck is one of parts of semiconductor equipments to temporarily attach or detach a silicon wafer on apparatuses used to produce semiconductors such as apparatuses for PCVD (Plasma Chemical Vapor Deposition), etching, etc. by electrostatic force generated by dielectric polarization. Therefore, the electro-static chuck has a structure adapted to generate static electricity between plasma and the chuck in the chamber so that the entire surface can be attached thereto. Here, the chuck is, of course, provided with a dielectric as a source of electrostatic force and an electrode for application of voltage. Specially, for a dry type process, the chuck is prepared by selecting materials having excellent dielectric properties and thermal conductivity since accurate and uniform heating/cooling in vacuum, temperature distribution and electrostatic force are required to improve uniformity of a thin layer and to reduce thermal stress and defect density. It is important to prepare this part so that the dielectric can control uniform electrostatic force and temperature on the chuck.

Generally, the electrode to induce static electricity is inserted in the dielectric in a floating form and is wired to the back of the chuck to apply voltage between the chamber and plasma.

Materials used in most of the electro-static chucks include polyimide, aluminum oxide (Al₂O₃/black Al₂O₃), silicone rubber, aluminum nitride (AlN) and the like, and among them, aluminum nitride (AlN) has particularly high dielectric constant and high thermal conductivity as compared to other coating materials, as shown in Table showing characteristics of several coating materials. Further, it has excellent plasma resistance and thus, is spotlighted as a dielectric material henceforth.

TABLE 1

| | Static | Thermal | Plasma |
|---|---|---|---|
| Materials | electricity | conductivity | resistance |
| Epoxy | ◯ | X | Δ |
| Polyimide | ◯ | X | ◯ |
| Silicone | ◯ | ⊚ | Δ |
| rubber | | | |
| Al₂O₃ | ⊚ | ◯ | ⊚ |
| AlN | ⊚ | ⊚ | ⊚ |

⊚: Excellent, ◯: good, Δ: fair, X: poor

Meanwhile, in the conventional preparation of the electro-static chucks, the dielectric is sintered after the electrode is inserted. However, aluminum nitride (AlN) is a poor sinterable material which is hardly sintered, and thus, even when it is sintered, the attachment between the dielectric of sintered aluminum nitride (AlN) and the substrate is inferior. Therefore, in order to use aluminum nitride (AlN) as a dielectric material, it is desired to have a novel method in a non-sintered way.

Also, in some electro-static chucks recently produced applying a non-sintered method, a bulk of aluminum nitride/electrode/aluminum nitride is formed by inserting an electrode, subjected to sintering and attached to an aluminum substrate (the basic chuck) using an adhesive. However, in these cases, there are problems in that the adhesion between the bulk and the substrate is significantly poor and arching may occurs during the process due to nonuniformity at the adhered part.

Therefore, it is desired to develop an electro-static chuck employing aluminum nitride (AlN) as a dielectric.

### DISCLOSURE OF INVENTION

### Technical Problem

Therefore, the present invention has been made in order to solve the problems involved in the prior art, and it is an object of the present invention to provide an electro-static chuck comprising a dielectric formed of aluminum nitride (AlN) without a sintering and adhering process.

It is another object of the present invention to provide an electro-static chuck having excellent electrostatic properties, bonding strength and thermal conductivity.

It is a further object of the present invention to provide a method for preparing an electro-static chuck which comprises depositing aluminum nitride by coating, whereby it is possible to select a material for a substrate having low melting point and high thermal conductivity and to produce the electro-static chuck at the low production cost and high productivity.

### TECHNICAL SOLUTION

In order to achieve the above objects, according to the present invention, there is provided an electro-static chuck with non-sintered aluminum nitride (AlN) comprising a dielectric formed of a coating layer of aluminum nitride.

Also, the present invention provides a method for producing an electro-static chuck with non-sintered aluminum nitride (AlN) comprising sequentially laminating a substrate, an insulating layer, an electrode and a dielectric from the bottom, in which the dielectric is formed by coating aluminum nitride.

### ADVANTAGEOUS EFFECT

According to the present invention, the electro-static chuck comprises a dielectric formed of aluminum nitride (AlN) by coating. By employing the aluminum nitride layer as a dielectric to improve properties of the electro-static chuck, it is possible to prepare an electro-static chuck having excellent electrostatic properties and thermal conductivity and improved bonding strength and thermal conductivity since it can be prepared without sintering or adhering.

Thus, since the sintering process is not needed, aluminum nitride (AlN) can be applied as a dielectric and thereby, the produced electro-static chuck may have high static electricity, high dielectric constant, high thermal conductivity and high plasma resistance.

Also, in the method for preparing the electro-static chuck with non-sintered aluminum nitride (AlN) according to the present invention, it is possible to perform a low temperature process upon application of cold spray coating, whereby it is possible to avoid defects involved in hot spray coating. Further, in the physical aspects, since the coating material is deposited to form a layer in the solid state, it is possible to maintain the properties of the coating material and to prevent oxidation of a substrate as a basic material. In addition, it is possible to select low melting point materials as a substrate material, resulting in expansion of selection range of substrate materials. Therefore, advantageously, it is possible to use metallic materials having low melting point and high thermal conductivity, to avoid problems associated with oxidation, since aluminum nitride (AlN) is coated by cold spray coating without sintering. Also, it is possible to reduce residual stress of the substrate, to produce a coating layer having high density, high strength and work hardening, and to form a thick low oxidative layer. Further, it is possible to simultaneously provide low porosity (>99% Dense, As-coated) and high coating efficiency (>98%) and to mass-produce electro-static chucks at the low production cost.

However, the present invention is not to be restricted by the particular illustrative embodiments and attached drawings but only by the appended claims. It is to be appreciated that those skilled in the art can change or modify the embodiments without departing from the scope and spirit of the present invention and the change and modification will be fall in the scope of the present invention.

### BRIEF DESCRIPTION OF DRAWINGS

Further objects and advantages of the invention can be more fully understood from the following detailed description taken in conjunction with the accompanying drawings in which:

FIG. 1 is a sectional view of an example of the electro-static chuck with non-sintered aluminum nitride according to the present invention;

FIG. 2 is a plane view of an example of the electro-static chuck with non-sintered aluminum nitride according to the present invention;

FIG. 3 is a graph showing the coating efficiency according to the average powder rate upon using the cold spray coating method; and

FIG. 4 is a schematic view of the cold spray coating system according to the present invention.

### MODE FOR INVENTION

The present invention is directed to an electro-static chuck with non-sintered aluminum nitride, in which a dielectric layer is formed of a coating layer of non-sintered aluminum nitride.

Now, the electro-static chuck with non-sintered aluminum nitride according to the present invention will be described in detail with reference to the attached drawings.

In a preferred embodiment, the electro-static chuck with non-sintered aluminum nitride (AlN) according to the present invention comprises a substrate 20, an insulator 15, n electrode 30 and a dielectric 10.

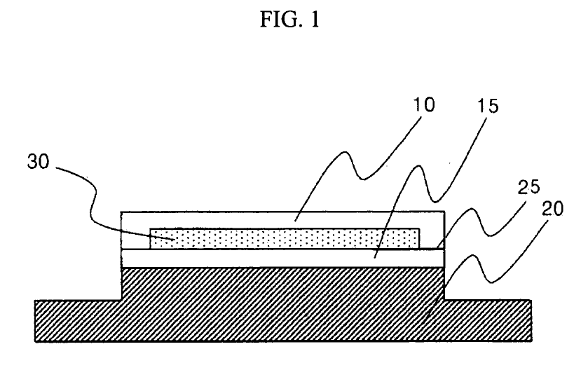

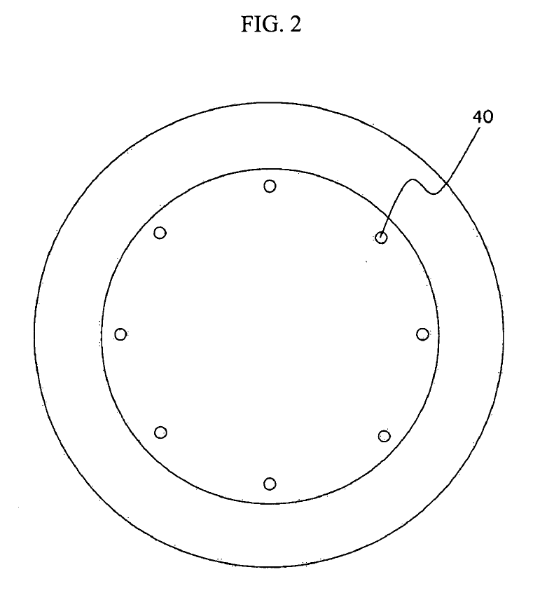

FIG. 1 and FIG. 2 show a sectional view and a plane view, respectively, of an embodiment of the electro-static chuck with non-sintered aluminum nitride (AlN) according to the present invention.

In the electro-static chuck with non-sintered aluminum nitride (AlN) according to the present invention, the coating layer of aluminum nitride may be formed through various coating methods.

Particularly, the coating layer according to the present invention may be formed by any one of, for example, vapor deposition, thermal spray or cold spray. The foregoing coating methods are largely classified into two types of vapor deposition methods and spray methods. Useful examples of the vapor deposition methods include Pulsed Laser Deposition (PLD), sputtering, evaporation, Chemical Vapor Deposition (CVD) and the like and useful examples of the spray methods include plasma spray coating, High Velocity Oxy-Fuel (HVOF), thermal spray coating, cold spray coating and the like.

Among them, the cold spray coating is preferably used since particles accelerated by supersonic speed are coated at a temperature lower than melting points of the substrate and particles, whereby the particles can maintain their properties and the coating can be carried out without change in the properties of the substrate. Also, the cold spray can simultaneously solve the problems involved in the conventional spray coating such as oxidation of the substrate, stress of the substrate and unfitness for low-melting point substrates.

In a preferred embodiment according to the present invention, as shown in FIG. 1 to FIG. 2, the electro-static chuck comprises a substrate 20, an insulator 15, an electrode 30 and a dielectric 10 from the bottom.

Therefore, the electro-static chuck comprises the substrate 20 formed of aluminum alloy, copper, copper alloy or ceramic, a first aluminum nitride (AlN) layer 15 formed on the substrate by cold spray coating, an electrode 30 formed with a separation 25 of a distance from the circumference of the first aluminum nitride to the center on the first aluminum nitride (AlN) layer 15 and a second aluminum nitride (AlN) layer 10 formed by cold spray coating to cover the whole of the electrode 30 and the separation 25.

The substrate 20 may be formed using common substrate materials and its useful examples include preferably aluminum alloy, copper, copper alloy or ceramic materials in terms of thermal conductivity or chemical stability, more preferably an anodized 6xxx series aluminum alloy having good points in terms of mechanical strength, thermal conductivity and weight.

The insulator 15 formed on the substrate 20 acts to prevent electric current between substrate 20 and electrode 30 and may be formed using common insulating materials. According to the present invention, aluminum nitride (AlN) is used as a material for the insulator and the insulating layer is deposited by coating, preferably cold spray coating to form the first aluminum nitride layer 15. Considering insulating properties and workability, the insulating layer 15 has a thickness of 0.2 to 1.5 mm, preferably 0.5 to 0.9 mm, more preferably about 0.7 mm.

Also, the electrode 30 is formed on the insulating layer 15 and deposited by various coating methods, preferably the cold spray coating, considering bonding strength. Preferably, the electrode 30 is formed with the separation 25 of a distance from the circumference of the first aluminum nitride (AlN) layer 15 to the center and the separation acts to maintain insulation upon arc generation caused by exposure of the electro-static chuck to the outside. In other words, the surface of the electrode layer is located inward from the circumference of the first aluminum nitride layer so that it may not be exposed to the outside. Through this configuration, the electrode may be completely insulated by aluminum nitride.

According to the present invention, materials and thickness of the electrode 30 are not particularly limited as long as the electrode 30 can generate a sufficient electro-static force to fix a wafer and the skilled in the art may thus select from various conductive materials known to the art, including tin, copper, silver (Ag), aluminum and the like, and shapes. In case of the electro-static chuck used to fix an 8 inch wafer, the electrode 30 is preferably formed of tin, silver (Ag), aluminum or copper and has a thickness of preferably 0.01 to 0.5 mm, more preferably about 0.1 mm to secure the optimum electrostatic force and construction of the electro-static chuck.

According to the present invention, the electrode 30 may be formed with a single electrode or two electrodes, in which the electrode 30 with a single electrode or two electrodes is classified into a unipolar type or bipolar type, respectively. In the present invention, both types of electrodes are applicable.

Also, the dielectric 10 is formed by coating aluminum nitride (AlN) on the electrode 30 to insulate the electrode 30 and to generate static electricity. Thus, as shown in FIG. 1 to FIG. 2, it is formed to cover the whole of the electrode 30 and the separation 25. According to the present invention, since the aluminum nitride layer (dielectric layer 10) is formed on the electrode 30 by coating such as cold spray coating, it is possible to solve the problem related to the difficulty of sintering and to provide all the advantages in using aluminum nitride as a dielectric. Preferably, the dielectric 10 has a thickness of 0.05 to 1 mm, more preferably about 0.2 mm to secure the optimum construction and electrostatic force of the electro-static chuck

The electro-static chuck with non-sintered aluminum nitride (AlN) according to the present invention may be further provided with auxiliary openings 40 for air supply as needed for the construction of equipments and process, as shown in FIG. 2.

In the electro-static chuck with non-sintered aluminum nitride (AlN) according to the present invention, an electric power is applied to the electrode through wiring at the back side of the chuck to generate the static electricity by interaction between the dielectric 10 and the electrode 30.

The conventional electro-static chuck using aluminum nitride as a material for the dielectric layer 10 is manufactured through sintering of aluminum nitride (AlN). However, there are difficulties in the process since aluminum is hardly sintered. According to the present invention, since the electro-static chuck with non-sintered aluminum nitride (AlN) is manufactured without performing the sintering process, the problems involved in the conventional chuck may be solved and it is also possible to employ aluminum nitride (AlN), which has a high dielectric constant and excellent thermal conductivity, as a dielectric without sintering.

According to the present invention, there is also provided a method for producing the electro-static chuck with non-sintered aluminum nitride (AlN). The method for producing the electro-static chuck comprises coating aluminum nitride to form a dielectric of the electro-static chuck.

As the method to perform the coating, various coating methods known to the art can be used and a concrete example include any one of vapor deposition, thermal spray and cold spray. The foregoing coating methods are classified into two types of vapor deposition methods and spray methods in a large way. Examples of useful vapor deposition methods include Pulsed Laser Deposition (PLD), sputtering, evaporation, Chemical Vapor Deposition (CVD) and the like and examples of useful spray methods include plasma spray coating, High Velocity Oxy-Fuel (HVOF) coating, thermal spray coating, cold spray coating and the like.

Preferably, the coating of aluminum nitride is performed by cold spray coating of aluminum nitride powder since the particles can maintain their properties and the coating can be effected without change in the properties of the substrate. Also, the cold spray coating can solve the problems involved in the conventional spray coating such as oxidation of the substrate, stress of the substrate and unfitness for low-melting point substrates.

The electro-static chuck of the embodiment as shown in FIG. 1 to FIG. 2 may be prepared by a method comprising a step for forming a first layer 15, in which aluminum nitride powder is deposited on the substrate 20 by cold spray coating to form the first aluminum nitride layer 15 as an insulating layer, a step for forming a second layer 30, in which conductive powder is deposited on the first layer 15 by cold spray coating to form the electrode 30 comprising the separation 25 of a distance from the circumference of the first layer 15 to the center, and a step for forming a third layer 10, in which aluminum nitride powder is deposited on the second layer 30 and the separation 25 by cold spray coating to form an aluminum nitride layer.

Also, the preparing method may further comprise a step for leveling the coating layer which has been formed in the previous step before performing the subsequent coating step, considering surface roughness of the coating surface and the coating efficiency. In the end, after the third layer is formed, a final leveling step may be further carried out. In addition, the conductive powder used in the step for forming the electrode (the second layer) may be various powders having conductivity and preferable examples include conductive metal, particularly tin powder and the like.

The cold spray coating which is used to prepare the electro-static chuck according to the present invention will be concretely described as follows.

The cold spray coating is one of the cold spray coating methods using supersonic speed, in which coating is performed by striking fine particles accelerated by supersonic gas-jet stream of a gas against a substrate of a metal or ceramic to form a coating layer. Generally, the coating method can be affected by process variables including gas temperature, gas type, distance from the substrate, powder supply rate (a function of gas flux, pressure, gas speed, ratio between gas and powder), composition of powder, particle size, additives, viscosity, feeding method (high pressure/low pressure type) and the like.

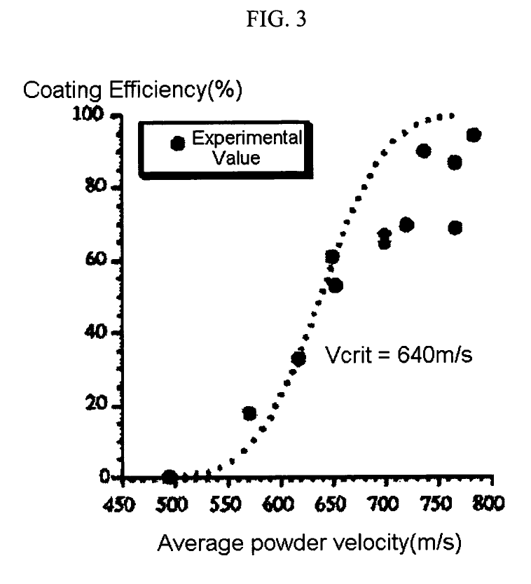

Particularly, since the coating is performed by collision of particles accelerated at high speed against a substrate which has not been heated, the coating efficiency depends on respective materials to be used in the coating and increases, when the speed of the accelerated particles increases, showing abrupt increase over a certain speed. Thus, as shown in the graph of coating efficiency according to particle speed of FIG. 3, the coating efficiency is divided into two specific zone; one is a zone where the accelerated particles dot not reach the critical velocity (Vcrit) and the other is a zone where the accelerated particles exceed the critical velocity. In the first zone (V<Vcrit), no coating is performed on the substrate and in the second zone where the particles are accelerated over the critical velocity, coating is performed on the substrate.

The fundamental requirements for the cold spray coating using supersonic speed is to spray fine particles at high speed without temperature elevation. Preferred conditions for such requirements are as follows: a) the temperature of jet stream should be lower than the melting points or softening points of particles to be accelerated; b) the particles to be accelerated have a particle size of 1 to 50 μm; c) the particles have a velocity of 300 to 1200 m/s, depending on material and size of particles. In practice, the particles are coated by help of supersonic gas-jet stream of about Mach 2 to 4 at 1 to 3 MPa.

Usable gas can be various types and includes preferably air, nitrogen, helium, gas mixture, considering inactivity and stability. Without regard to the used gas, the coating will be carried out only when the particles are accelerated over the critical velocity (V>Vcrit). Meanwhile, it is generally known that the accelerated particle velocity is fast in the order of helium>nitrogen>air and thus, the coating efficiency when helium is used is the highest. However, the helium gas is insufficiently competitive in the economical aspects. Air may be preferably used considering the economical aspects.

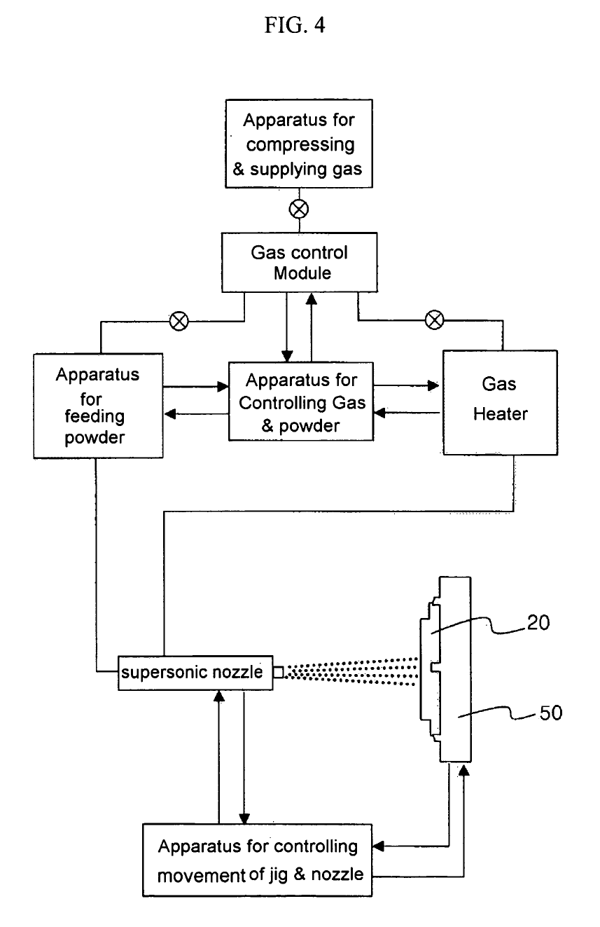

Also, for the cold spray process, since the high-velocity gas should be sprayed for a long period of time, a large quantity of gas flow is needed. Therefore, gas temperature may be elevated to attain a required gas velocity. FIG. 4 shows a schematic view of a system using the cold spray coating method to prepare the electro-static chuck with non-sintered aluminum nitride (AlN) according to the present invention. Compressed gas is heated while passing through a gas heater and the heated gas then passes through a neck of a nozzle to form a supersonic gas-jet stream. Subsequently, particles which have been injected through a nozzle get into the supersonic gas stream and collide against a substrate to form a coating layer. Preferably, the gas is set to a temperature in the range of 100 to 700° C. with a deviation of ±3° C. for gas spraying at high-velocity and uniform feeding and the gas flow is set to 300 to 500 l/min.

Specially, In case of the gas temperature, it is known that the coating efficiency increases when the temperature of the sprayed gas increases. Therefore, the gas temperature may be raised to increase the coating efficiency of the cold spray coating method. However, after the gas temperature reaches a certain level, the coating efficiency is maintained constant and thus, the foregoing temperature range is preferred for supply of gas in a sufficient flow rate. Also, it has been found that when the gas is heated prior to spraying the coating efficiency is similar to the coating efficiency when the gas is sprayed without heating, which indicates that the heating prior to the spraying does not affect the coating efficiency. For these reasons, it is necessary to increase the temperature of the gas to be accelerated, among the process variables for improving the coating efficiency, and for mass-production where a large amount of gas is used, a large-scale heating apparatus is needed to maintain a uniform temperature after the gas flows out.

Compressed gas thus obtained is then supplied to one side of the nozzle. Meanwhile, aluminum nitride powder is injected to the other side of the nozzle, get into the supersonic gas stream and is sprayed against a substrate to form a coating layer. The nozzle may be various shapes and does not exert a critical influence on the coating efficiency. However, for mass-production, there is a need to shorten the process time and to reduce the production cost. Thus, the nozzle is preferably designed in a rectangular shape of a typical De Laval type showing excellent uniformity and coating rate. Also, the nozzle size may be properly adjusted to optimize the gas flow and coating rate.

The aluminum nitride powder supplied through the nozzle may have various particle sizes according to the desired conditions of the coating layer and preferably have a size of 1 to 150 μm in terms of mass-production and yield, more preferably 1 to 50 μm in terms of the coating efficiency.

Also, the powder may be used along with an additive such as a dispersing agent and thereby, particularly when the powder has a high viscosity, a low pressure powder feeding apparatus as well as a high pressure feeding apparatus for cold spray coating may be used.

The aluminum nitride powder used in the high pressure powder feeding apparatus and the low pressure feeding apparatus for cold spray coating may be aluminum nitride alone or in combination with additives such as a dispersing agent and a binder, which include polyimide, glass resin, polyvinyl alcohol, epoxy, pine resin, rubber resin, polyethyl glycol, polyvinylbutyral, phenol resin, poly ester, acrylamide, glass frit and the like. Preferably, considering dielectric constant, adhesion and applicability at high temperature, the aluminum nitride powder is used in combination with 10 to 30% by weight of polyimide, glass resin, PVA (polyvinyl alcohol) or a mixture thereof, and then pulverized. By using the mixture with additives, it is possible to increase the coating efficiency and adhesion of the aluminum nitride powder. More preferably, the aluminum nitride powder is combined with 15 to 20% by weight of polyimide, glass resin, PVA or a mixture thereof.

The powder mixture of aluminum nitride with the additives is preferably ball milled, dried, pulverized and passed through a sieve to provide aluminum nitride powder ready for coating. It is preferable that the pulverized mixture powder is screened to obtain a predetermined size. Though various size of powder may be used according to coating conditions, the powder screened with a sieve of 150 μm may be preferably used, considering mass production, surface roughness and bonding. The resulting powder is then supplied to the nozzle through a powder feeding apparatus. Here, the powder is continuously and uniformly supplied in a rate of 100 to 150 cm/hr at high pressure without cohesion.

In practice, as described above, the coating process variables to improve the coating efficiency of the cold spray coating and properties of the produced coating layer include gas temperature, gas types, distance from the substrate, powder feeding rate (a function of gas flux, pressure, gas velocity, ratio between gas and powder), composition of powder, particle size, additives, viscosity, feeding method (high pressure/low pressure type) and the like.

It is shown that the distance between the substrate and the nozzle is closely associated with the coating efficiency. When helium gas is used, as the distance to the substrate increases, the coating efficiency decreases. It is believed that this is because when the distance to the substrate increases, the velocity of the accelerated particles decreases and consequently, there occurs no reaction (plastic deformation) between the colliding particles but elastic deformation, resulting in reduction of the coating efficiency. Meanwhile, upon using air, the coating efficiency slightly increases, while the distance increases to a certain distance. However, when the distance is over the certain distance, the coating efficiency suddenly decreases, which indicates that there exists a critical distance.

On the basis of the foregoing description, the preferred process conditions include a temperature of gas used to accelerate particles of 400 to 500° C., a gas pressure of 3 to 7 kgf/cm, and a distance between the nozzle and the substrate of 5 to 50 mm. More preferably, the gas temperature is about 450° C., the gas pressure is 5 to 6 kgf/cm and the distance is 20 to 30 mm.

Thickness of each layer of the electro-static chuck with non-sintered aluminum nitride prepared according to the present invention varies depending on the wafer type. For an 8 inch wafer, as described above, it is preferred that the first aluminum nitride layer (the first layer) as an insulating layer has a thickness of 0.2 to 1.5 mm, the electrode (the second layer) has a thickness of 0.01 to 0.5 mm, the aluminum nitride layer (the third layer) as a dielectric layer has a thickness of 0.05 to 1 mm.

For optimum coating, the coating surface may be subjected to a leveling treatment. Concretely, the leveling performed by controlling a jig 50 for fixing and moving the substrate. Here, the movement of the substrate may be an up and down and from side to side movement or a rotation system. For the former case, the moving speed can be a process variable while for the other, the rotation speed can be a process variable.

Meanwhile, the jig for the chuck can be prepared to move on X-Y axis or to have a movement system of rotation (5^{˜}50 RPM)+1 axis movement for uniform surface roughness of the coating in the electro-static chuck. Also, it is possible to provide an interface of a control system to link the movements of the jig and nozzle.

Also, preferably, the produced coating surface may be subjected to a leveling treatment after completion of the coating. Concretely, as an equipment for the surface treatment of the produced aluminum nitride (AlN) coating layer, a lathe for rotary forming and a milling apparatus may be used since the resulting product to be processed has a disc shape. Further, as the treatment is for a coating layer, it is possible to design and manufacture equipments using processing apparatuses exclusive for delicate ceramics, unlike in the surface treatment of ceramic bulks.

In addition, the method according to the present invention may further comprise, after the step for forming the third layer, a step for curing the electro-static chuck after completion of the coating and leveling the surface, and a step for forming auxiliary openings on the chuck after completion of the curing. By this, it is possible to improve bonding strength and density of the coating layer and also to remove the additives where the powder has been combined with the additives.

Though the curing temperature may vary according to the used additives, it is preferably 100 to 500° C. to effectively carry out the burn-out of the additives.

### INDUSTRIAL APPLICABILITY

The electro-static chuck comprising non-sintered aluminum nitride as a dielectric prepared according to the present invention has a dielectric constant of at least 8 (measured at a frequency of 100 KHz to 1 MHz), typically 8 to 9, an electrostatic force of at least 150 gf/cm, typically 150 to 200 gf/cm, when a voltage of 500 V is applied. Also, the electro-static chuck has excellent properties such as adhesion, uniform temperature distribution, thermal expansion coefficient, and thermal conductivity. For example, the electro-static chuck according to the present invention has an adhesion of 0.3 to 0.5 MPa, a temperature distribution of about ±3° C. a thermal expansion coefficient of 4.7×10⁻⁶/K and a thermal conductivity of 50 to 80 W/m/K. Therefore, the electro-static chuck according to the present invention may be used at a temperature of the range of −50 to 500° C. and be prepared to have a surface roughness/coplanarity of Ra≦0.25 μm/3 μm.

The electro-static chuck with non-sintered aluminum nitride according to the present invention can be applied to fix wafers in the etching process or CVD process, in which the process temperature is preferably −40 to 500° C.

1. An electro-static chuck with non-sintered aluminum nitride (AlN) comprising a coating layer of aluminum nitride as a dielectric of the electro-static chuck.

2. The electro-static chuck according to claim 1, in which the coating layer of aluminum nitride is formed by depositing aluminum nitride powder by cold spray coating.

3. The electro-static chuck according to claim 1, in which the electro-static chuck comprises:
a substrate formed of aluminum alloy, copper, copper alloy or ceramic;
a first aluminum nitride (AlN) layer formed on the substrate by cold spray coating;
an electrode formed with a separation of a distance from the circumference of the first aluminum nitride to the center on the first aluminum nitride (AlN) layer; and
a second aluminum nitride (AlN) layer formed by cold spray coating to cover the whole of the electrode and the separation.

4. The electro-static chuck according to claim 3, in which the first aluminum nitride layer has a thickness of 0.2 to 1.5 mm, the electrode has a thickness of 0.01 to 0.5 mm, and the second aluminum nitride layer has a thickness of 0.05 to 1 mm.

5. A method for preparing an electro-static chuck with non-sintered aluminum nitride (AlN) comprising coating aluminum nitride as a dielectric on the electro-static chuck.

6. The method according to claim 5, in which the coating of aluminum nitride is performed by depositing aluminum nitride powder by cold spray coating.

7. The method according to claim 5, which comprises:
a step for forming a first layer, in which aluminum nitride powder is deposited on a substrate by cold spray coating to form a first aluminum nitride layer as an insulating layer;
a step for forming a second layer, in which conductive powder is deposited on the first layer by cold spray coating to form an electrode with a separation of a distance from the circumference of the first layer to the center; and
a step for forming a third layer, in which aluminum nitride powder is deposited on the second layer and the separation by cold spray coating to form an aluminum nitride layer.

8. The method according to claim 5, in which the cold spray coating is performed at a gas temperature of 400 to 500° C., a gas pressure of 3 to 7 kgf/cm², and a distance between the nozzle and the substrate of 5 to 50 mm.

9. The method according to claim 5, in which the aluminum nitride powder is combined with 10 to 30% by weight of polyimide, glass resin, polyvinyl alcohol or a mixture thereof, and pulverized.

10. The method according to claim 9, in which the pulverized mixture powder is screened to obtain a predetermined size.

11. The method according to claim 7, in which the first layer has a thickness of 0.2 to 1.5 mm, the second layer has a thickness of 0.01 to 0.5 mm, and the third layer has a thickness of 0.05 to 1 mm.

12. The method of claim 7, which further comprises, after the step for forming the third layer:
a step for curing the electro-static chuck after completion of the coating and leveling the surface; and
a step for forming auxiliary openings on the chuck after completion of the curing.

13. The method according to claim 12, in which the curing is performed at a temperature of 100 to 500° C.

14. An electro-static chuck with non-sintered aluminum nitride (AlN) prepared by the method according to claim 5, which has a dielectric constant of at least 8, measured at a frequency of 100 KHz to 1 MHz and an electrostatic force of at least 150 gf/cm², when a voltage of 500 V is applied.
